(19) United States
(12) Patent Application Publication
(10) Pub. No.: US 2021/0083395 A1
(43) Pub. Date: Mar. 18, 2021

(54) METHOD AND APPARATUS FOR OBJECT DETECTION INCORPORATING METAMATERIAL ANTENNA SIDE LOBE FEATURES

(71) Applicant: Metawave Corporation, Carlsbad, CA (US)

(72) Inventors: Maha ACHOUR, Carlsbad, CA (US); Shoaib SHAFI, Carlsbad, CA (US); Abdullah ZAIDI, Carlsbad, CA (US); Tom ZARIAN, Carlsbad, CA (US)

(21) Appl. No.: 17/046,288

(22) PCT Filed: Apr. 12, 2019
(86) PCT No.: PCT/US2019/027398

§ 371 Date: Oct. 8, 2020

Related U.S. Application Data
(60) Provisional application No. 62/656,903, filed on Apr. 12, 2018.

(51) Int. Cl. H01Q 15/00; G01S 13/931; G01S 7/28; H01Q 1/32

(52) U.S. Cl. CPC H01Q 15/0086; G01S 13/931; G01S 2013/0254; H01Q 1/3233; G01S 2013/93271; G01S 7/2813

(57) ABSTRACT

The present inventions provide methods and apparatuses for a metamaterial antenna structure, wherein a half-power illumination area of a side lobe of an electromagnetic transmission detect objects.

### CROSS-REFERENCE TO RELATED APPLICATIONS

This application is U.S. national phase of International Application No. PCT/US2019/027398, filed Apr. 12, 2019, which claims priority to U.S. Provisional Application No. 62/656,903, filed on Apr. 12, 2018, and incorporated herein by reference.

### FIELD OF THE INVENTION

The present invention relates to wireless systems, and specifically to radar systems for object detection using metamaterial devices.

### BACKGROUND

Radar antennas are designed to focus power on the area of interest, while reducing the losses associated with side lobes of the radiated signal. Many designs seek to reduce the size of the side lobes, while optimizing the energy available for object detection.

### BRIEF DESCRIPTION OF THE DRAWINGS

The present application may be more fully appreciated in connection with the following detailed description taken in conjunction with the accompanying drawings, which are not drawn to scale and in which like reference characters refer to like parts throughout, and wherein:

FIG. 1 illustrates a field of view in a vehicle, according to embodiments of the present invention;

FIG. 2 illustrates a radar unit applied to the vehicle and the corresponding lobes of an electromagnetic radiation transmission, according to embodiments of the present invention;

FIG. 3 illustrates a flow diagram of operation of a radar system as in FIG. 2, according to embodiments of the present invention;

FIG. 4 illustrates orientations of the main transmission signal lobes, according to embodiments of the present invention;

FIG. 5 illustrates a system having transmit and receive antennas, according to embodiments of the present invention;

FIG. 6 illustrates an antenna system, according to embodiments of the present invention;

FIG. 7 illustrates antenna and control system, according to embodiments of the present invention; and

FIGS. 8 and 9 illustrate antenna guard element radiation patterns and detection scenarios, according to embodiments of the present invention.

### DETAILED DESCRIPTION

To optimize the power used in a radar system, while expanding the field of view of the radar, the present invention provides methods and apparatuses to incorporate signals received from the side lobes of a radar transmission. In some embodiments, the range and angle of arrival are used to determine detection in a main lobe or in a side lobe of a radar system. In some embodiments, antenna guard elements are implemented to detect objects outside of the main lobe. The antenna system is made up of multiple antenna elements, such as an antenna array having multiple radiating elements, which may be metamaterial elements, meta-structure elements, or other radiating element structures.

These and other challenges may be resolved with the present inventions, providing metamaterial antenna designs for object detection. The metamaterial designs may be implemented using conductive materials formed in small structures, enabling accurate direction of transmission beams and control of the beams without digital beam forming technology, but rather controlling operation of the antenna by changing the reactance characteristics of the metamaterial elements.

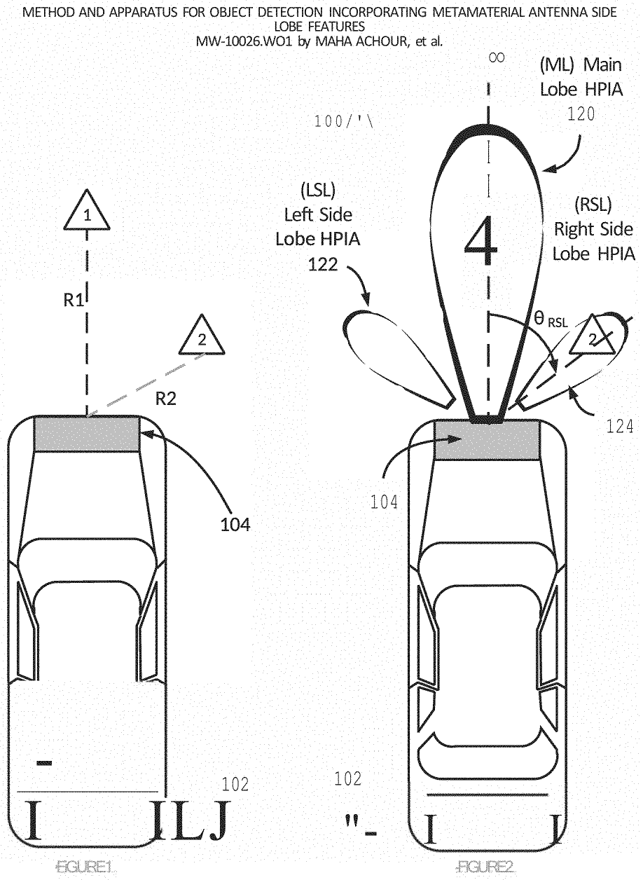

As illustrated in FIG. 1, a vehicle 102 has a radar unit 104, which may have a single antenna array for transmit and receive operation, or may have separate antenna arrays or elements for transmit operation and receive operation. The radar unit 104 operates to generate a radiation beam having a main lobe and one or more side lobes. The specific pattern generated may be changed by active elements in the radar unit 104 that enable beam steering, beam switching, and/or other mechanism for radiation beam generation. The beam steering may be done according to a regular raster scan method or may be adjusted based on response and detected objects in the field of view.

As illustrated in FIG. 1, positioned directly in front of the vehicle 102 is an object 1, and to the side is an object 2. The goal and operation of the radar unit 104 is to detect any objects that may be in the path of the vehicle 102 and determine an appropriate action in response, which may be an automated response or an alert to a driver. Such a system may be implemented in an Automated Driver Assist System (“ADAS”) to provide guidance information to the driver of the vehicle or may be implemented in an autonomous vehicle that does not require human intervention. The vehicle 102 may have other sensors working in coordination with, or concurrently with, the radar unit 104. The radar unit 104 has an antenna which may take any of a variety of configurations. Similarly, the radar unit 104 may include multiple radar sensors positioned along or within the vehicle.

The vehicle 102 may also include a central control system, sometimes referred to as a sensor fusion, taking in information from multiple sensors around a vehicle. The sensor fusion takes the signals and operates according to a scheme designed to control the vehicle in a safe manner. The ability for the sensor fusion to make decisions is based on the accuracy of the received data. For safety, the various sensors may be coordinated so as to optimize the benefits and strengths of each type of sensor. The radar unit 104 provides key sensor information, as the radar unit 104 is able to operate in all types of weather conditions and has a long range of object detection. This is critical for operation of a vehicle at speeds of 60 mph and above.

The ability to detect the object and then classify it is part of some of the embodiments presented herein, where the various conditions are used to generate a perception engine that receives the radar detection information and data received, echoes and reflections, and determines a classification for an object given the detection information. Using analog information to determine the specific inputs to the perception engine, such as an Artificial Intelligence (“AI”) engine, the perception engine outputs a classification. In operation, the classification is given as a probability of one or more object types. In the present embodiments, the perception engine may incorporate multiple engines, where one is used to classify objects from the main lobe and another one or more to classify objects from the one or more side lobes or guard lobes, discussed herein.

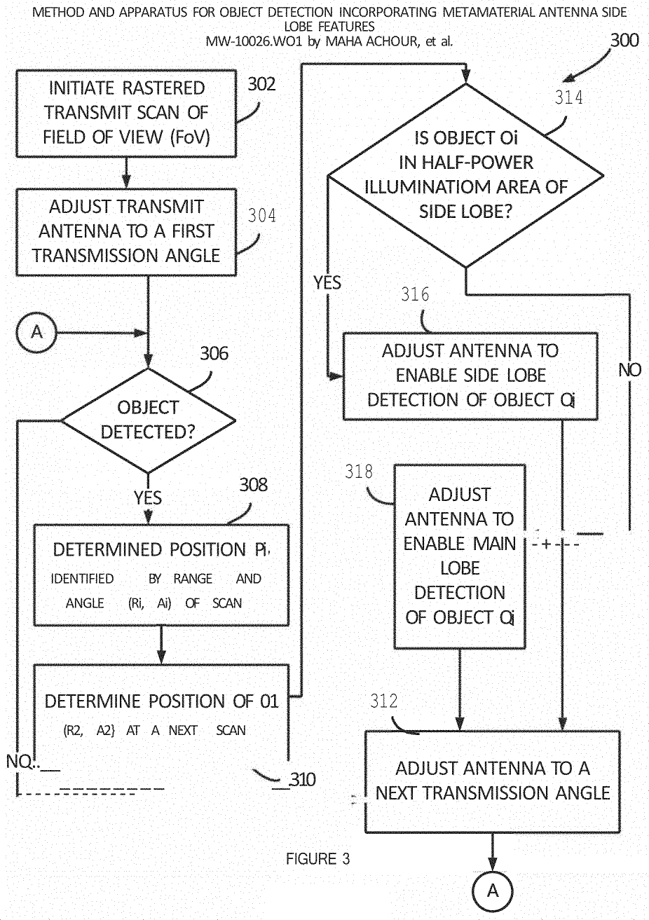

FIG. 2 illustrates a system 100 and the various radar beamforms from the radar unit 104. A main lobe (“ML”) 120 is directed to detect objects in the direct path of the vehicle 102. The object 1, O₁, falls within the field of view of ML 120 which is illustrated as the detection area. This is the area in which the receive antenna of radar unit 104 receives return signals from objects therein. The illustrated object O₁ is positioned in a direct line of sight at 0° angle, referred to as boresight, with respect to the direction of the vehicle 102. The beamform transmitted from radar unit 104 has multiple side lobes, including the Right Side Lobe (“RSL”) 124 and the Left Side Lobe (“LSL”) 122 which are illustrated by the detection areas outlined. The side lobes are a feature of the transmission of an Electromagnetic (“EM”) transmission beam and may take any of a variety of forms. Often the side lobes are difficult to determine and are not controlled smoothly.

In some of the present embodiments, the radar unit 104 has a receive antenna that receives the echoes from objects positioned within the detection area of the side lobes and provides a practical extension to the detection area capabilities of the ML 120; reflections of radar signals from objects in the side lobes, 122, 124, provide object detection information. With a Frequency Modulated Continuous Waveform (“FMCW”) waveform, for example, the return signals are used to determine a range to an object as well as the velocity of such object. By additional processing, the radar unit 104 may be able to detect an angle of arrival allowing a true location of the object with respect to the vehicle 102. As an example, RSL 124 reflects object 2, O₂, and may be used to identify that object in that location which falls in the detection area of the RSL 124. The object location is identified by the reflection angle.

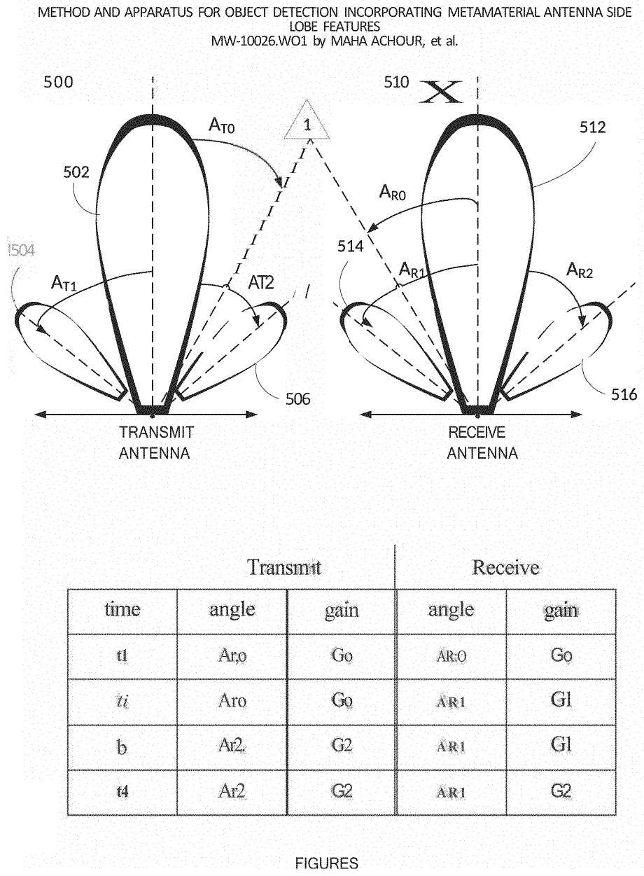

The area in which the antenna of radar unit 104 is able to detect an object within each lobe is referred to as the Half-Power Illumination Area (“HPIA”). An antenna system generates a radiation signal having a shape and direction, wherein each of the main lobe, side lobes and guard lobe has a distinct HPIA. Generally, the side lobes are dependent on the main lobe direction, gain and characteristic, so that changing the direction of the main beam, changes the detection area of the side lobes as well. To determine the HPIA associated with a given main lobe direction, the radar unit 104 considers the various angular adjustments that each lobe is able to achieve, such as illustrated in FIG. 4. In this way, the main lobe and side lobes are able to cover a broader area than that of the main lobe alone. In many antenna applications, the only objects detectable are in the main lobe; however, the present invention enables detection of objects in multiple HPIAs and enables scanning of a given area as well as specific directed movements in response to the environment. For example, if an object is detected in a side lobe, the radar unit 104 may change the direction of the main beam so as to capture the object(s).

In the scenario of FIG. 2, the main beam has an HPIA that will detect object 1, referred to as a target and identified herein as O₁, positioned directly in the path of the vehicle 102. As the vehicle 102 continues directly ahead, the radar will continue to detect this target O₁ and take appropriate actions. Additionally, there is an object 2, target O₂, within the HPIA of the RSL 124. On detection by the RSL, the radar unit 104 may take any of a variety of actions to adjust the antenna to capture or track the target 2. In one scenario, the radar unit 104 adjusts the transmit antenna to direct the main lobe at an angle wherein the HPIA captures the target O₂. In another scenario, the radar unit 104 adjusts the transmit antenna to direct the RSL 124 at an angle wherein the HPIA captures the target O₂. In these scenarios, the receive antenna or receiver is coordinated with the transmit operation and may be adjusted accordingly.

Conventional radar units are designed to minimize the size of the side lobes of radiation; however, the present invention may be applied in situations where the side lobes are larger than acceptable in other applications. The present invention optimizes use of the radiation pattern from the radar by incorporating information from the side lobes and considering the side lobe HPIA as part of a combined capability of the radar unit, such as the radar unit 104. The present invention is also applicable to detection of multiple objects in a cluttered environment. While the main lobe HPIA captures target O₁ in the boresight of the radar, the RSL 124 HPIA captures target O₂.

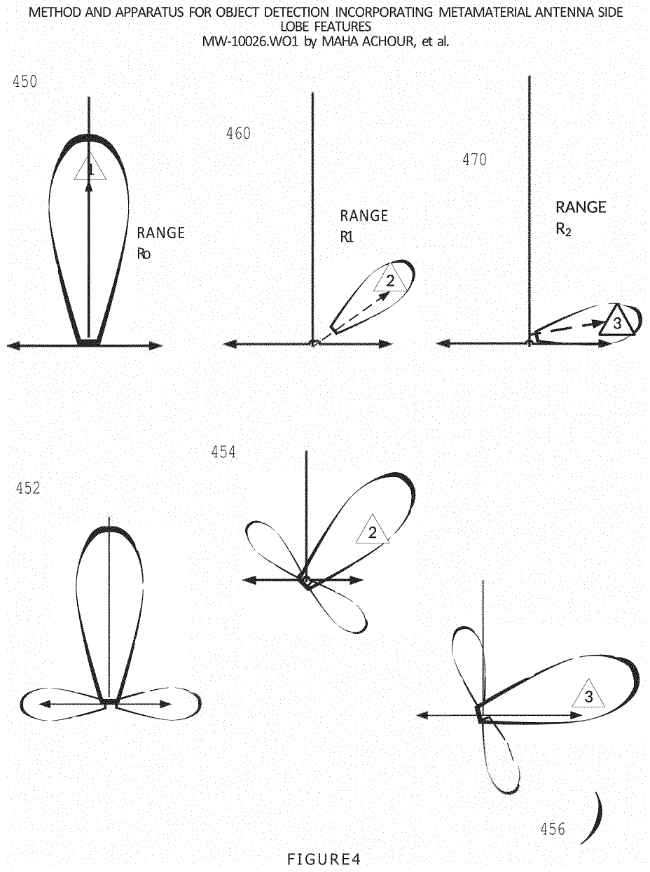

FIG. 3 illustrates a process 300 according to some embodiments of the present invention for controlling the radar unit 104. The process 300 initiates a scan, such as a raster-type scan, of the transmitter, 302, where the antenna is directed within the Field-of-View (“FoV”) of the radar unit 104. This means that the antenna is directed to one or more angles with respect to the boresight direction in the path of the vehicle. As used herein, the FoV refers to the area within which the antenna unit 104 is capable of detecting an object; this includes the HPIA of the antenna during transmission over the range of the directivity and beamforms of which the radar unit 104 is capable.

Control of the antenna elements within radar unit 104 may be controlled by adjusting the control parameters, including the transmit direction, receive direction, transmit gain, receive gain, and others. The antenna direction and gain may be adjusted by phase shifting the antenna elements and adjusting the power supplied to the antenna elements. There are a variety of methods for performing the scan, including cycling through angles in a predetermined pattern, adjusting the direction dynamically in response to objects and conditions detected in the environment, and other custom schemes.

In some embodiments, the antenna is a metamaterial (“MTM”) antenna or a meta-structure antenna, structured to enable phase shifting by way of reactance control elements coupled to the antenna elements. A meta-structure element is an engineered structure with electromagnetic properties not found in nature, where the index of refraction may take any value, and the structure may be aperiodic, periodic, or partially periodic (semi-periodic). The meta-structure manipulates electromagnetic wave phase as function of frequency and spatial distribution. Phase controllers may be distributed along a radio front end, radiating elements and meta-structures. These structures may be passive and or active elements.

Continuing with FIG. 3, the process 300 then adjusts the transmit antenna to a first transmission angle, 304, such as according to the scan sequence of angles and transmission parameters. If an object is detected, 306, the process determines a position Pᵢ of the detected object, or target i, and identifies same by the range, or distance, to the target i, and the angle, Aᵢ, 308. The identification may be processed and/or stored as a range-Doppler mapping of range and angle (R, A). The angle is measured with respect to a default direction, such as to the boresight of the antenna. If no object is detected, 308, the process then continues the scan, 312, such as a raster scan.

When an object is detected, the radar unit 104 determines where the target i will be located at a next scan, and determines an adjustment, if any, to the radar angle to capture the target i. If the object is stationary the radar adjustment will account for the motion of the vehicle 102 and determine where the object will be with respect to the radar unit 104, however, the radar unit 104 may need multiple transmissions to determine the motion of the target i. Note, where the radar unit 104 incorporates a modulation type, such as FMCW, the velocity and/or acceleration of the target i may be determined from one or a few transmission cycles and therefore the radar may need only scan at one angle to predict the spatial relationship between the radar unit 104 and the target i, and then continue with the raster scan 312. If the object is not within the HPIA of a side lobe, 314, the radar unit 104 will adjust the antenna to enable main lobe detection of the target i.

Continuing with FIG. 3 and process 300, adjustment of the antenna considers adjustments of the transmit and receive antennas, where they are separate elements. The radar unit 104 creates beamforms on the receive antenna that correspond to that of the transmit antenna and enable the receive antenna to detect any objects that are within the HPIA of the transmit antenna. There are a variety of controls that the radar unit 104 may implement to achieve detection of objects within the HPIA of the main lobe or side lobes of the antenna. If the target i is within an HPIA of a side lobe, 314, the antenna unit 104 may adjust the antenna to enable side lobe detection of the target i, 316. Else processing continues to adjust the antenna, 318, to enable main lobe detection of the target i, Oᵢ, and adjust antenna to a next transmission angle, 312. Processing then continues to determine if an object was detected, 306. In this way, the main lobe is redirected when an object is detected in a side lobe. The process of determining the object in the side lobe uses the angle of arrival and range information, which is processed by radar unit 104 on object detection.

The movement or redirection of the main lobe is illustrated in FIG. 4 where a main lobe HPIA 450 is illustrated at boresight, and the side lobes are illustrated as HPIA set 452. In this position, the radar unit is able to identify an object at range R₀. When an object is detected in a side lobe HPIA 460, the antenna is redirected at an angle toward the angle of the detected object O₂, as illustrated in HPIA 454, allowing the main lobe to detect the object O₂. Similarly, if a side lobe 470 detects another object, O₃, the main beam is redirected as illustrated in HPIA 456. Each detected object has an associated range and angle of arrival enabling this control of the main lobe. Note that other events, objects, and conditions may trigger redirection of a main lobe, such as where an object is detected and foretells of another object in a different area. This is the case, for example, where multiple cyclists are moving in a train or peloton of cyclists. This often happens on weekends, mornings and evenings. Once a first cyclist is detected, the radar unit 104 may redirect the main lobe so as to capture other cyclists' locations.

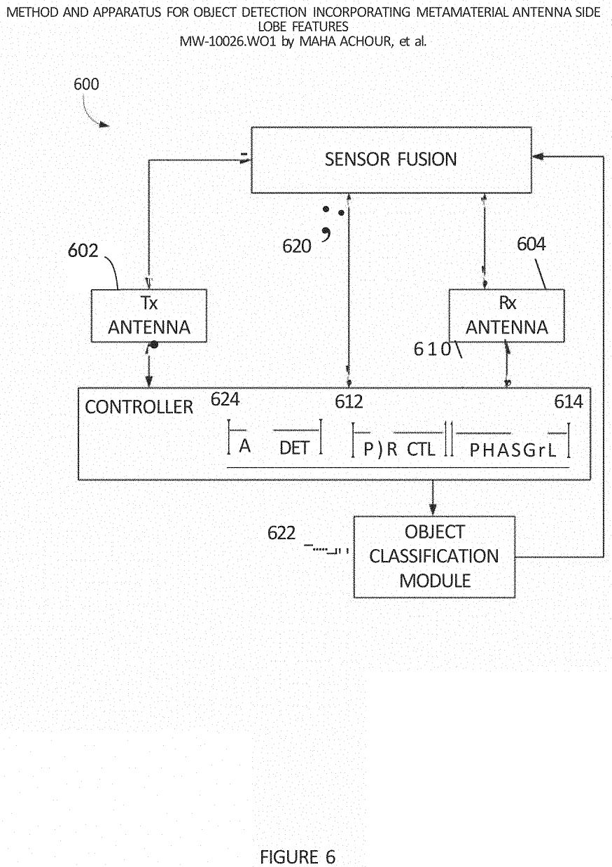

An example is illustrated in FIG. 5, where an object, target i, is positioned proximate the transmit antenna 500 and receive antenna 510, which may be separate antennas in a radar system. The transmit antenna 500 is positioned such that the main lobe HPIA 502 will detect the target O₁ when positioned at angle, A_{T0}. The transmit antenna 500 has side lobe HPIAs 504, 506. As the radar unit 104 scans the FoV, the transmit antenna 500 is adjusted to this angle. The receive antenna 510 detects or tracks the object when the main lobe HPIA 512 or the LSL HPIA 514 is positioned at angle A_{R0}. The radar unit 104 creates beamforms on the receive antenna 510 that correspond to that of the transmit antenna 500 and enable the receive antenna 510 to detect any objects that are within the HPIA 502, of the transmit antenna. There are a variety of controls that the radar unit 104 may implement to achieve detection of objects within the HPIA of the main lobe or side lobes of the antenna. If the target Oᵢ is within an HPIA of a side lobe, 514, the antenna unit 104 may adjust the receive antenna 510 to enable side lobe detection of the target Oᵢ, 516. There may be a fixed relationship between an axis of the main lobe to an axis of each side lobe formed, such as A_{T1}, A_{T2}. These angles may change when the direction of the main lobe and the direction of the transmit antenna 500, is changed.

It is appreciated that the example of FIG. 5 is a system having separate transmit and receive antenna elements; but these operations may be similarly implemented in a transceiver module using a single antenna, such as in a duplex configuration. The transmit antenna and receive antenna operation are adjusted by controlling the angle of transmission of the transmit antenna and the receive direction of the receive antenna and adjusting the gain of each. As illustrated in the table, at time t₁, the transmit antenna is directed at angle, A_{T0}, and has a gain, G₀. At the same time, t₁, the receive antenna is directed at angle, A_{R0}, and has gain, G₀. These initial positions and power conditions are a result of and part of the raster scan operation for the antenna, where the receive and transmit antenna are coordinated. The receive antenna detects target O₁, and the radar unit 104 changes the direction of the receive antenna to position an HPIA at A_{R1}. This is intended to position the receive antenna to continue to capture or track target 1. The gain in this scenario is also changed to G₁. The adjustment of the receive antenna may act to position the main lobe or the LSL to the next angle. At time t₂, the transmit antenna angle remains at A_{T0}, the receive antenna angle changes to A_{R1} with Gain G₁. At time t₃, the transmit antenna angle changes to A_{T2} with gain G₂, and the receive antenna remains in its previous configuration. At time t₄ the receive antenna changes the gain to G₂.

In these examples, the parameters of the antenna elements are adjusted to optimize the object detection capabilities of the radar unit 104. By controlling the angle of the transmit antenna 500 and receive antenna 510 and the gain of the antennas 500, 510, the radar unit 104 is able to detect objects in an increased area. There are a variety of other responses and adjustments that may be made in response to a detected object. Additional parameters may be considered and used for this enhanced detection and tracking. Also, other sensors within the vehicle 102 may be triggered on detection of an object, such as where a given object has a position and velocity that would prompt an additional monitor by a laser or camera, and so forth.

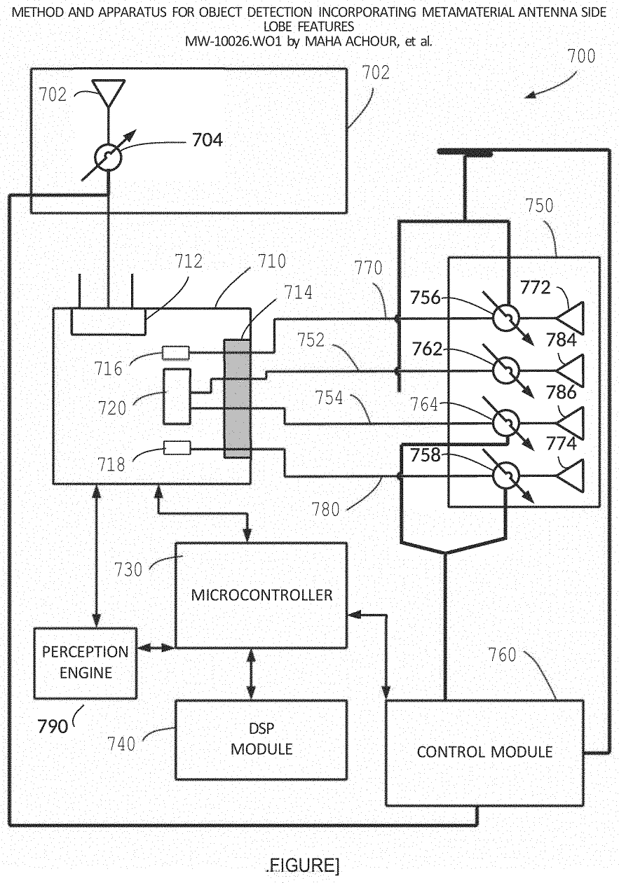

FIG. 6 illustrates an example system 600 implementing a radar unit 104 having antenna elements 602, 604, controller 610 for the antenna, and an object classification module 622. The various components of system 600 communicate with the sensor fusion 620, which receives feedback from the antennas and modules and also provides instructions, data and guidance as specified. The object classification module 622 receives the antenna information and determines a class of the object, such as pedestrian, building, vehicle, and so forth. The power control 612 adjusts the gain of the antennas. The phase control 614 adjusts the phase of the antennas and in some embodiments controls the reactance of antenna elements. The object classification module 622 receives information from the antennas 602, 604, which is processed for presentation to the module 622 by various processes which may include Analog-to-Digital (“A-D”) conversion, FFT processing, absolute value determination, log scaling and so forth. An Angle-of-Arrival (“AoA”) determination module 624 uses the modulated signals and reflections to determine the arrival angle which along with range locates the object. The velocity of the object may also be used for determination of location and classification. The detected information is then provided to sensor fusion 620 which acts to control or alert the vehicle and/or driver.

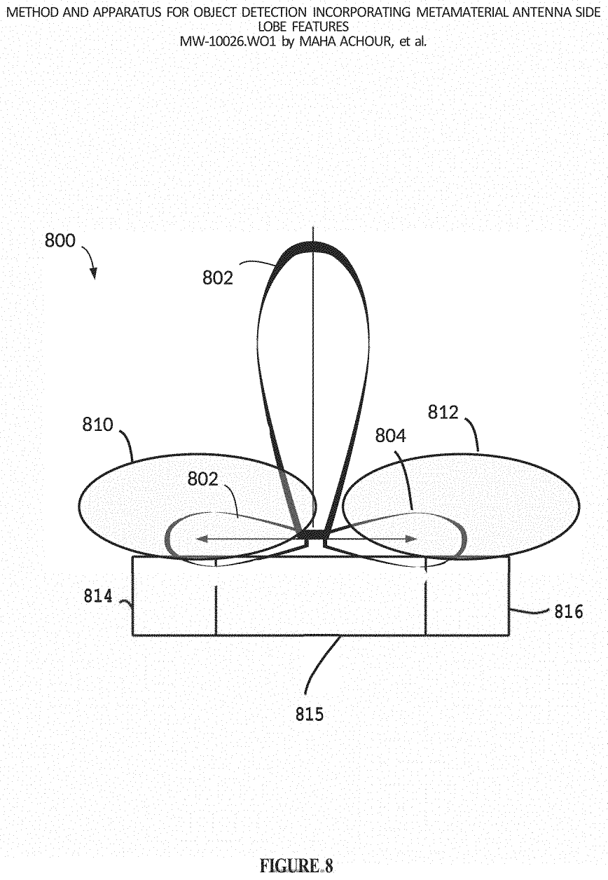

FIG. 7 illustrates an antenna system implementing methods for expanding the field of view of the antenna while reducing/cancelling side lobe radiation patterns from a main antenna. As illustrated, the system 700 is controlled by a microcontroller 730 providing instructions, signals and data throughout the system 700, and specifically to RF module 710. The microcontroller 730 also works with Digital Signal Processing (“DSP”) module 740 and control module 760, wherein control module 760 provides control signals to the phase controllers of the system. In some embodiments, the control module 760 is a Field Gate Programmable Array (“FPGA”) customizable to the circuit, design and application of system 700.

The RF module 710 is a Radio Frequency (“RF”) module including feed structure 720 coupled to main antennas 784, 786 via transmission paths 752, 754 having phase controllers 762, 764, respectively, positioned between feed structure 720 and antenna radiating elements 784, 786, respectively. These elements 784, 786 form the main antenna within an antenna system 750. There may be any number of antenna elements in a variety of configurations. The antenna elements within antenna structure 750 forms a radiation beam, such as for a radar system, wherein the beam has a main beam and side beams as illustrated in FIG. 2, wherein the illustrated beam outlines an HPIA within which an object may be detected. The radiation has main lobe and one or more side lobes. The system 700 implements multiple guard elements, fed from guard feed structures 716, 718 through transmission paths 770, 780 to antenna elements 772, 774, respectively. These may be formed and/or positioned within antenna system 750 or may be separate from the main antennas 784, 786.

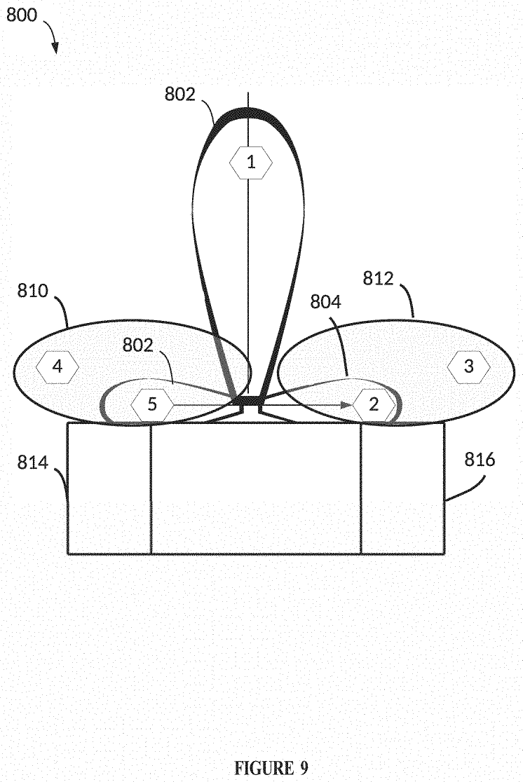

The guard elements include phase shifters 756, 758, respectively, wherein they are operated at a specific operating condition different from that of the main antenna elements 784, 786. Again, these are illustrated as examples of antenna structures, wherein each antenna element 784, 786 may have an array structure, a linear structure, a random patterned-structure, an asymmetric structure of radiating elements and so forth. The control module 760 provides a control condition, such as a bias voltage or bias signal, to the phase shifters throughout system 700. The control module 760 controls the phase of the guard elements, 756, 758, differently from the phase shifters of the main antenna elements 764, 766, wherein the main antenna elements 784, 786, result in a main radiation beam. The guard elements 772, 774, result in individual beam formations, as illustrated in FIG. 8.

FIG. 8 illustrates an antenna structure 800 having guard elements 814, 816 which have separate feeds and controls for phase, gain and so forth, which serve to isolate the radiation beams from the guard elements 814, 816. The phase controls are used to direct and steer the beams 810, 812 formed therefrom. As illustrated, the beams 810, 812 overlap the side lobes 802, 804 associated with the main antenna radiation beam 802. In this way, the guard elements are structured super elements comprised of vectors or arrays of radiating elements. There a variety of structures that may be used to construct the antenna 800, wherein different structures may be implemented in the main antenna portion 815 and the guard elements 815, 816.

FIG. 9 illustrates the detection range of the present inventions, wherein a first target is detected in a main lobe 802 of antenna 800. A second target is detected in side lobe 804 and a third in guard element beam 812. Still further a fourth target is detected in guard element beam 810 and a fifth in side lobe 802. These may be detected concurrently or sequentially where received reflections indicate a next location. In these embodiments, as illustrated in FIG. 9, the targets within side lobes 802, 804, are detected within the guard element beams 810, 812. The ability to reduce or remove the side lobes by introduction of guard elements enables a refined detection capability, as many of the targets therein may be detected without use of angle of arrival calculations.

The present invention presents methods and apparatuses for object detection expanded through use of side lobe detection and/or guard element detection. The embodiments presented herein may be incorporated into a variety of antenna structures, radiating elements, phase control mechanisms, object classification techniques and so forth. This provides a powerful tool for sensor fusion in applications such as automotive sensing and control.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method for object detection, comprising:
initiating a scan from a radar antenna unit:
transmitting an electromagnetic beamform having a main lobe and side lobes, wherein the main lobe and side lobes each have a corresponding half-power illumination area;
detecting an object in at least one of the half-power illumination areas; and
adjusting the antenna such that the object is located within a side lobe half-power illumination area of the antenna.

2. The method of claim 1, wherein adjusting the antenna comprises adjusting the gain of the antenna.

3. The method of claim 1, wherein adjusting the antenna comprises adjusting the angle of the antenna with respect to a reference direction.

4. The method of claim 3, wherein the antenna comprises a metamaterial array of elements and adjusting the angle of the antenna comprises changing a reactance of at least one of the elements of the metamaterial array.

5. An antenna system, comprising:
an antenna comprising a metamaterial array of elements; and
an antenna controller coupled to the antenna and configured to:
determine the location of an object;
determine a target radiation pattern to track the object, wherein the radiation pattern includes a main lobe and at least one side lobe; and
adjust parameters of the antenna so as to change a location of a half-power illumination area of a side lobe of the target radiation pattern.

6. The antenna system as in claim 5, further comprising a power controller coupled to the antenna and configured to change the gain of the antenna.

7. A radar system, comprising:
a receive antenna having a plurality of radiating elements and at least one guard element, wherein the plurality of radiating elements are meta-structure elements;
a radio controller providing separate feeds to the plurality of radiating elements and the at least one guard element;
a phase control module adapted to control phase control units coupled to the plurality of radiating elements and the at least one guard element; and
a controller to determine a direction of a radiation beam from the plurality of radiating elements.

8. The radar system as in claim 7, wherein the radio controller has a main lobe feed structure and at least one guard lobe feed structure.

9. The radar system as in claim 8, wherein control of the phase controllers changes the direction of the radiation beam.

10. The radar system as in claim 9, wherein the main lobe feed structure provides a signal to the plurality of radiating elements at a first set of parameters and wherein the at least one guard lobe feed structure provides a second signal to the at least one guard element at a second set of parameters different from the first set of parameters.

11. The radar system as in claim 10, wherein the controller is adapted to generate the radiation beam separate from a guard radiation beam from the guard elements, wherein the guard radiation beam overlaps side lobe portions of the radiation beam.

12. The radar system as in claim 11, further comprising an angle of arrival calculation unit.

13. The radar system as in claim 12, further comprising a perception engine for classification of detected objects.

14. The radar system as in claim 10, wherein the controller is adapted to generate the radiation beam separate from a guard radiation beam from the guard elements, wherein the guard radiation beam overlaps a portion of side lobe portions of the radiation beam.

15. The radar system as in claim 14, wherein the system changes a direction of the radiation beam in response to detection of an object in a side lobe beam.

16. The radar system as in claim 1, wherein each radiation beam generated by the receive antenna and the at least one guard element are defined by a half power illumination area.

17. A method for object detection, comprising:
detecting an object within a side lobe of an antenna; and
adjusting the antenna directivity to position the side lobe of the antenna.

18. The method as in claim 17, further comprising:
determining an angle of arrival of a reflection from the object.

19. The method as in claim 18, wherein the angle of arrival identifies location of the object in the side lobe.

20. The method as in claim 19, further comprising adjusting a direction and a gain of the antenna in response to detecting the object.
